(19) United States
(12) Patent Application Publication
(10) Pub. No.: US 2025/0324406 A1
(43) Pub. Date: Oct. 16, 2025

(54) FREQUENCY-DOMAIN RESOURCE DETERMINATION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/861,058

(22) PCT Filed: Apr. 28, 2022
(86) PCT No.: PCT/CN2022/090084

§ 371 Date: Oct. 28, 2024

(51) Int. Cl. H04W 72/0453; H04L 1/00; H04W 72/21

(52) U.S. Cl. CPC H04W 72/0453; H04L 1/0003; H04L 1/0009; H04W 72/21

(57) ABSTRACT

A method, apparatus and computer readable medium for determining a frequency domain resource in a wireless communication network. The frequency domain resource is determined by: determining, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station; where the antenna panels transmit the PUSCH transmission by using wave beams, directions of the wave beams used by different antenna panels are indicated by wave beam direction indication information, and the wave beam direction indication information includes: transmission configuration indication (TCI) or a source indication parameter of a sounding reference signal (SRS).

### CROSS-REFERENCE TO RELATED APPLICATIONS

The present application is a U.S. National Stage of International Application No. PCT/CN2022/090084, filed on Apr. 28, 2022, the contents of which are incorporated herein by reference in their entirety for all purposes.

### BACKGROUND OF THE INVENTION

In order to improve cell-edge coverage and provide more balanced quality of service within a service area, multi-point coordination is still a crucial technical means in a new radio (NR) system.

### SUMMARY OF THE INVENTION

Examples of the disclosure provide a method and apparatus for determining a frequency domain resource, a communication device, and a storage medium.

A first aspect of the examples of the disclosure provides a method for determining a frequency domain resource. The method includes:
determining, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station.

The antenna panels transmit the PUSCH transmission by using wave beams. Directions of the wave beams used by different antenna panels are indicated by wave beam direction indication information. The wave beam direction indication information includes: transmission configuration indication (TCI) or a source indication parameter of a sounding reference signal (SRS).

Another aspect of the examples of the disclosure provides a communication device. The communication device includes a processor, a transceiver, a memory, and an executable program stored in the memory and capable of being run by the processor. When the processor runs the executable program, the method for determining a frequency domain resource provided in the above first aspect is executed.

Another aspect of the examples of the disclosure provides a non-transitory computer storage medium. The computer storage medium stores an executable program. After the executable program is executed by a processor, the method for determining a frequency domain resource provided in the above first aspect may be implemented.

It should be understood that the above general descriptions and the following detailed descriptions are illustrative and explanatory merely, and cannot limit examples of the disclosure.

### BRIEF DESCRIPTION OF DRAWINGS

Accompanying drawings herein are incorporated into the description as a constituent part of the description, illustrate examples conforming to the disclosure, and serve to explain principles of examples of the disclosure along with the description.

FIG. 1 is a schematic structural diagram of a wireless communication system according to an example;

FIG. 2 is a schematic flow diagram of a method for determining a frequency domain resource according to an example;

FIG. 3 is a schematic diagram of transmission of a plurality of antenna panels of a terminal according to an example;

FIG. 4 is a schematic diagram of transmission coding of a plurality of antenna panels of a terminal according to an example;

FIG. 5 is a schematic diagram of distribution of frequency domain resources according to an example;

FIG. 6 is a schematic flow diagram of a method for determining a frequency domain resource according to an example;

FIG. 7 is a schematic flow diagram of a method for determining a frequency domain resource according to an example;

FIG. 8 is a schematic structural diagram of an apparatus for determining a frequency domain resource according to an example;

FIG. 9 is a schematic structural diagram of a terminal according to an example; and

FIG. 10 is a schematic structural diagram of a communication device according to an example.

### DETAILED DESCRIPTION OF THE INVENTION

Examples will be described in detail here and illustratively shown in the accompanying drawings. When the following descriptions involve accompanying drawings, unless otherwise specified, the same numeral in different accompanying drawings denotes the same or similar elements. Embodiments described in the following examples do not denote all embodiments consistent with examples of the disclosure. On the contrary, the embodiments are merely instances of an apparatus and a method consistent with some aspects of examples of the disclosure.

Terms used in examples of the disclosure are merely used to describe particular examples, and are not intended to limit examples of the disclosure. The singular forms “a,” “an” “the” and “this” used in the disclosure are also intended to include the plural forms, unless otherwise clearly stated in the context. It should also be understood that the term “and/or” used here refers to and includes any or all possible combinations of one or more of associated listed items.

It should be understood that although terms “first,” “second,” “third,” etc. may be used in examples of the disclosure to describe various types of information, such information should not be limited to these terms. These terms are merely used to distinguish the same type of information from each other. For instance, first information can also be referred to as second information, and similarly, second information can also be referred to as first information, without departing from the scope of examples of the disclosure. Depending on the context, the word “if” as used here can be interpreted as “when,” “in a case that” or “in response to determining”.

From the perspective of network topology, when network deployment with plenty of distributed access points and centralized baseband processing is performed, a balanced user experience rate can be advantageously provided, and a delay and signaling overhead caused by handover can be significantly reduced.

As a frequency band increases, relatively dense access point deployment is also required for ensuring network coverage. In a high-frequency band, as an integration level of active antenna devices is improved, modular active antenna arrays are more likely to be adopted. An antenna array of each transmission reception point (TRP) can be divided into several relatively independent antenna panels. Thus, a form of the entire array and a number of ports can be flexibly adjusted according to deployment scenarios and service requirements.

Further, the antenna panels or TRPs can be connected to each other by means of optical fibers, so as to perform more flexible distributed deployment.

In a millimeter wave band, blocking effects of obstacles such as a human body or a vehicle will be more obvious as a wavelength decreases.

In this case, in order to ensure robustness of a link connection, transmission/reception can be performed from a plurality of wave beams at a plurality of angles through coordination between a plurality of TRPs or panels, thus reducing adverse effects caused by the blocking effects.

According to the technical solutions provided in the examples of the disclosure, if the plurality of antenna panels of the terminal are configured with corresponding TCI respectively, the plurality of antenna panels of the terminal can simultaneously carry out uplink transmission. Thus, throughput of a communication system can be improved, and a transmission reliability can be improved.

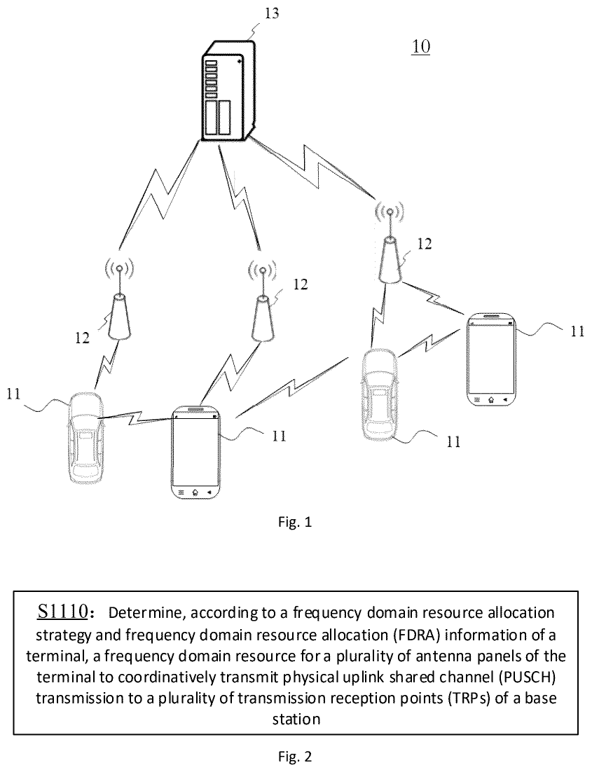

With reference to FIG. 1, a schematic structural diagram of a wireless communication system 10, which is shown as an example of the disclosure, is shown. As shown in FIG. 1, the wireless communication system 10 is a communication system based on a cellular mobile communication technology. This wireless communication system 10 may include several terminals 11 and several access devices 12.

The terminal 11 may refer to a device that provides voice and/or data connectivity for a user. The terminal 11 may be in communication with one or more core networks by means of a radio access network (RAN). The terminal 11 may be an internet of things terminal, such as a sensor device, a mobile phone (or referred to as a “cellular” phone), and a computer with an internet of things terminal, such as a stationary, portable, pocket-sized or hand-held apparatus, an apparatus built in a computer, or a vehicle-mounted apparatus, such as a station (STA), a subscriber unit, a subscriber station, a mobile station, a mobile, a remote station, an access point, a remote terminal, an access terminal, a user terminal, a user agent, a user device, or user equipment. The terminal 11 may be an unmanned aerial vehicle device. The terminal 11 may be a vehicle-mounted device, such as an electronic control unit with a wireless communication function, or a wireless communication device externally connected to an electronic control unit. The terminal 11 may be a roadside device, such as a street lamp, a signal lamp or other roadside devices with a wireless communication function.

The access device 12 may be a network-side device in a wireless communication system 10. This wireless communication system 10 may be the 4th generation mobile communication (4G) system, which is also referred to as a long term evolution (LTE) system. This wireless communication system 10 may be a 5G system, which is also referred to as a new radio (NR) system or a 5G NR system. This wireless communication system 10 may be a next generation system after the 5G system. An access network of the 5G system may be referred to as a new generation-radio access network (NG-RAN). The wireless communication system 10 may be a machine type communication (MTC) system.

The access device 12 may be an evolved node B (eNB) used in a 4G system. The access device 12 may be a generation node B (gNB) with a central and distributed architecture in a 5G system. In a case that the access device 12 has a central and distributed architecture, the base station generally includes a central unit (CU) and at least two distributed units (DUs). Protocol stacks of a packet data convergence protocol (PDCP) layer, a radio link control (RLC) layer and a media access control (MAC) layer are arranged in the central unit. A protocol stack of a physical (PHY) layer is arranged in the distributed unit. A specific implementation of the access device 12 is not limited in an example of the disclosure.

The access device 12 may be in wireless connection to the terminal 11 through radio. In different embodiments, this radio may be radio based on 4G standards. This radio may be radio based on 5G standards, for instance, this radio is new radio. This radio may be radio based on next generation mobile communication network technology standards of 5G.

As shown in FIG. 2, an example of the disclosure provides a method for determining a frequency domain resource. The method includes:

S1110: According to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station is determined.

The antenna panels transmit the PUSCH transmission by using wave beams. Directions of the wave beams used by different antenna panels are indicated by wave beam direction indication information. The wave beam direction indication information includes: transmission configuration indication (TCI) or a source indication parameter of a sounding reference signal (SRS).

The method for determining a frequency domain resource may be executed by a base station or a terminal.

The FDRA information indicates at least frequency domain resources allocated to the base station. Illustratively, the FDRA information may indicate a start position and an offset value of a resource block (RB) allocated to the terminal. Alternatively, the FDRA information indicates the start position and an end position of the RB allocated to the terminal. In an example of the disclosure, the FDRA information indicates frequency domain resources allocated to the terminal by the base station.

Illustratively, after receiving the FDRA information, the terminal allocates, according to the frequency domain resource allocation strategy, frequency domain resources indicated by the FDRA to frequency domain resources occupied when the PUSCH transmission is required to be transmitted to a plurality of TRPs.

In an example of the disclosure, one antenna panel of the terminal transmits the PUSCH transmission to one TRP of the base station. The plurality of antenna panels of the terminal may coordinately transmit the PUSCH transmission to the plurality of TRPs of the base station so that large bandwidth and high-rate PUSCH transmission can be implemented.

Illustratively, the terminal is provided with two antenna panels. One antenna panel may transmit the PUSCH transmission to one TRP of the base station.

Different terminals transmit the PUSCH transmission in different wave beam directions. For instance, the terminal is provided with two antenna panels, which are antenna panel 1 and antenna panel 2 respectively. Antenna panel 1 may be configured to transmit PUSCH transmission to TRP1, and antenna panel 2 may be configured to transmit PUSCH transmission to TRP2. Here, serial numbers of antenna panel 1 and antenna panel 2 and serial numbers of TRP1 and TRP2 are arbitrary serial numbers, and are merely used to distinguish different antenna panels and TRPs.

As shown in FIG. 4, after receiving a TB, the terminal performs encoding on the TB (41), then performs circular buffering on the encoded bits (42), such that a code word (CW) is obtained, and then maps the CW to a transmission layer (43). The transmission layers are mapped onto demodulation reference signal (DRMS) ports, and the transmission layers mapped onto the DRMS ports are precoded. In an example of the disclosure, assuming that the terminal is provided with two antenna panels, precoding 1 and precoding 2 may be performed respectively, and then PUSCH transmissions obtained after the precoding are transmitted to TRP1 and TRP2 respectively.

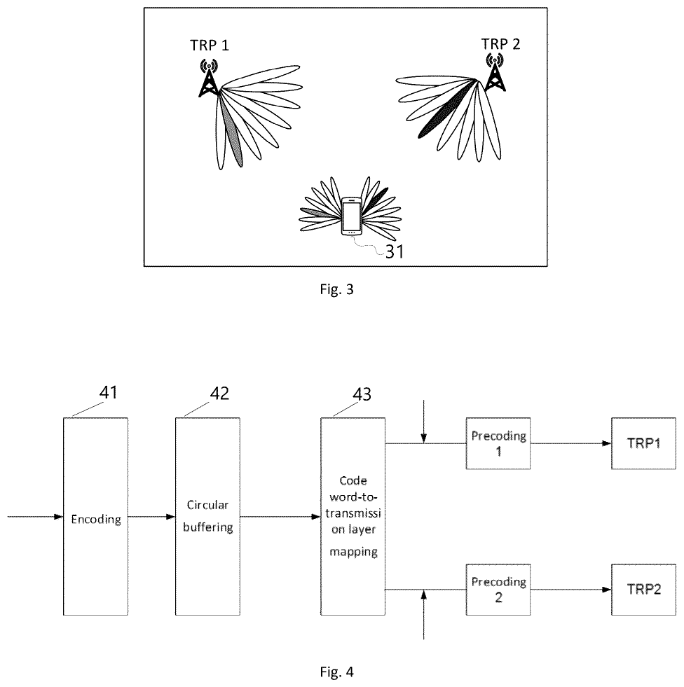

As shown in FIG. 3, one terminal 31 is provided with two antenna panels such that data can be simultaneously transmitted to TRP1 and TRP2 of a base station.

Directions of wave beams used by different antenna panels are independent. The wave beams used by the antenna panels may be indicated by TCI or a resource indication parameter of an SRS.

In an example, the TCI includes:
joint TCI;
independent TCI; and
spatial relation information.

In a case of a unified TCI framework configuration, the TCI may include: joint TCI and independent TCI.

A joint TCI may be used to determine directions of an uplink wave beam and a downlink wave beam. The uplink wave beam is used for uplink transmission and the downlink wave beam is used for downlink reception.

The independent TCI may be generally used for the direction of the uplink wave beam or the downlink wave beam. The wave beam direction of the uplink wave beam, and the independent TCI may be indicated by uplink (UL) TCI.

In some examples, indication information of the TCI has a plurality of TCI fields. One TCI field indicates TCI corresponding to one antenna panel of the terminal 31.

If the TCI in a case of the unified TCI framework configuration is not used, spatial relation info ½ can be used.

If the directions of the uplink wave beams of the different antenna panels of the terminal 31 are not indicated by the joint TCI or the independent TCI, the directions of the uplink wave beams of the different antenna panels of the terminal 31 can be indicated by using the spatial relation information.

Illustratively, the terminal 31 is provided with two antenna panels, the TCI is indicated by two TCI fields, and one TCI field indicates carry of one antenna panel.

In another example, the indication information of the TCI has a TCI field. Code points of the TCI field indicate the TCI of the plurality of antenna panels of the terminal 31.

In this case, the indication information of the TCI includes a unified TCI field. The TCI field includes one or more bits. Different bit values of these bits are different code points. Different code points of a TCI field may indicate the TCI of the plurality of antenna panels of the terminal 31.

Illustratively, the TCI field may be divided into a plurality of sub-fields. One sub-field indicates TCI of one antenna panel. One sub-field may include one or more bits.

Illustratively, one code point of the TCI field simultaneously corresponds to a combination of a plurality of TCI.

Further, SRS may be used to estimate a downlink channel and perform downlink wave beam forming. An SRS resource indicator (SRI) of an SRS may have a corresponding relation with a direction of an uplink wave beam. Thus, the SRI of the SRS is one type of TCI corresponding to different antenna panels of the terminal 31.

In some examples, the frequency domain resource allocation strategy includes:
a first strategy indicating that numbers of frequency domain resources used for the PUSCH transmission from the different antenna panels to the plurality of transmission reception points (TRPs) of the base station are balanced;
or
a second strategy indicating that numbers of frequency domain resources used by the different antenna panels are determined according to channel state information between the different antenna panels and the TRPs.

In an example, the first strategy may be a balance strategy, and is used to evenly allocate frequency domain resources among a plurality of antenna panels (for instance, two antenna panels).

The second strategy is a flexible allocation strategy, and can be used to allocate the number of frequency domain resources among a plurality of antenna panels (for instance, two antenna panels) according to actual requirements. By allocating frequency domain resources through such a method, if two antenna panels are taken as an instance, total frequency domain resources scheduled by the base station for the terminal will not be evenly distributed between the two antenna panels.

The channel state information may be various information feedbacking transmission channels between each antenna panel of terminal and TRPs.

Illustratively, the channel state information may indicate a measured value for a channel state reference signal of a channel condition, etc.

In cases of different channel conditions, unequal frequency domain resource numbers may be allocated such that communication between antenna panels having poor channels and TRPs can obtain more frequency domain gains. Thus, quality of transmission between antenna panels of the terminal and the TRPs can be ensured.

In an example of the disclosure, the first strategy and the second strategy may be used to determine number of frequency domain resources occupied by each antenna panel of the terminal.

In some examples, the frequency domain resources occupied by each antenna panel of the terminal may be distributed in various ways. For instance, the frequency domain resources occupied by each antenna panel are continuously distributed in a frequency domain, the frequency domain resources occupied by each antenna panel are distributed in a staggered manner, or the frequency domain resources occupied by each antenna panel are randomly distributed.

In an example, frequency domain resources corresponding to one antenna panel are continuously distributed in the frequency domain. For instance, frequency domain resources (such as RBs) occupied by one antenna panel of the terminal or one TRP are continuously distributed in the frequency domain.

As shown in a left-half portion of FIG. 5, a schematic diagram showing that frequency domain resources occupied by a single antenna panel or a single TRP are continuously distributed when a terminal provided with two antenna panels performs PUSCH transmission to two TRPs of a base station is shown.

In another example, as shown in a right-half portion of FIG. 5, the frequency domain resources used by the different antenna panels are distributed in a staggered manner in a predetermined frequency domain resource unit in the frequency domain.

Illustratively, RBs occupied by the different antenna panels are distributed in a staggered manner in the predetermined frequency domain resource unit in the frequency domain.

In another example, a schematic diagram showing that frequency domain resources occupied by two antenna panels and two TRPs are distributed in a staggered manner when a terminal provided with two antenna panels performs PUSCH transmission to two TRPs of a base station is shown.

The predetermined frequency domain resource unit includes:
one RB;
or one resource block group (RBG). One RBG includes one or more RBs.

If the predetermined frequency domain resource unit is RB, frequency domain resources occupied by the plurality of antenna panels of the terminal are distributed in a staggered manner in the frequency domain by RB.

One resource block group may include one or more RBs. If the predetermined frequency domain resource unit is RBG, frequency domain resources occupied by the plurality of antenna panels of the terminal are distributed in a staggered manner in the frequency domain by RBG.

In such a frequency domain resource allocation manner, the frequency domain resources for the antenna panels can be distributed in the frequency domain with different granularity.

It is assumed that the terminal is provided with M antenna panels, and M is a positive integer equal to or greater than 2. Moreover, frequency domain resource numbers are allocated by using the first strategy. The frequency domain resources occupied by the plurality of antenna panels of the terminal may be specifically distributed as follows:
a serial number of a frequency domain resource occupied by a first wave beam direction of the terminal is [0, floor(N_rb/M)−1], and a serial number of a frequency domain resource occupied by an mth antenna panel of the terminal is [floor(N_rb*(m−1)/M)−1, floor(N_rb*m/M)−1];
and alternatively,
a serial number of a frequency domain resource for an Mth antenna panel of the terminal is [0, floor(N_rb/M)−1], and a serial number of a frequency domain resource for the mth antenna panel of the terminal is [floor(N_rb*(M−m+1)/M)−1, floor(N_rb*(M−m)/M)−1].

Specifically, N_rb is a total number of frequency domain resources indicated by the frequency domain resource allocation (FDRA) information.

Moreover, m is a positive integer less than or equal to M.

Further, floor ( ) represents rounding down a values in the brackets.

In some examples, the frequency domain resource allocation strategy is the first strategy. The terminal is provided with two antenna panels.

A serial number of a frequency domain resource of a first wave beam direction is [0, floor(N_rb/2)−1], and a serial number of a frequency domain resource occupied by a second wave beam direction is (floor(N_rb*/2)−1, N_rb];
and alternatively,
a serial number of a frequency domain resource occupied by the second wave beam direction is [0, floor(N_rb/2)−1], and a serial number of a frequency domain resource of the first wave beam direction is (floor(N_rb*/2)−1, N_rb].

Specifically, N_rb is a total number of frequency domain resources indicated by the frequency domain resource allocation (FDRA) information.

The frequency domain resource serial numbers described here are all serial numbers in N_rb allocated to the terminal.

Illustratively, the frequency domain resource allocation strategy is the first strategy. The terminal is provided with two antenna panels.

A serial number of a frequency domain resources occupied by a first antenna panel is an odd number, and a serial number of a frequency domain resource occupied by a second antenna panel is an even number;
and alternatively,
a serial number of a frequency domain resource occupied by the first antenna panel is an even number, and a serial number of a frequency domain resource occupied by the second antenna panel is an odd number.

The frequency domain resource serial number here is the serial number of N_rb allocated to the terminal in the above predetermined frequency domain resource unit.

In some examples, the channel state information includes at least a channel quality indicator (CQI).

In some examples, the CQI represents current channel quality, corresponds to a signal-to-noise ratio of a channel, and has a value range from 0 to 31.

Modulation and coding schemes (MCSs) used by different types of channel state information are different, and code rates and/or modulation orders of the different MCSs are different.

The code rate is a number of data bits transmitted per unit time.

A communication system based on an autoencoder has a modulation order which defines a number of constellation points. The modulation order of the communication system based on the autoencoder defines a number of possible messages which a transmitter can generate and a receiver can decode. For instance, a modulation order of quadrature phase shift keying (QPSK) is generally 4. In this case, 4 different messages transmitted according to QPSK modulation can be encoded by a transmission terminal and decoded by a reception terminal. A modulation order of quadrature amplitude modulation (16QAM) is 16. In this case, 16 different messages can be generated by the transmission terminal and decoded by the reception terminal. The transmission terminal for PUSCH transmission here is the antenna panel of the above terminal, and the reception terminal is the above TRP.

In case of different code rates and modulation orders of the MAS, amounts of data after the same information bits are encoded are different. Thus, different frequency domain resource numbers may be required for PUSCH transmission.

In some examples, the frequency domain resource allocation strategy is the second strategy. The numbers of the frequency domain resources for the antenna panels are determined according to a ratio coefficient.

The ratio coefficient is determined according to code rates and modulation orders for the antenna panels of the terminal to perform the PUSCH transmission.

In an example, in a case that the terminal is provided with M antenna panels, the terminal has M wave beam directions.

Ratio coefficient Ratio_m1 or Ratio_m2 corresponding to an mth wave beam direction may be determined by using a functional relation as follows:

$$Ratio\_m1 = ( R 1 * Qm 1 , R 2 * Qm 2 … ( RM * QmM ) ; \\ or \\ Ratio\_m2 = Rm * Qmm / ( {\sum }_{y = 1}^{M} Ry * Qmy ) .$$

Specifically, Rm is a code rate of the mth antenna panel, and Qmm is a modulation order of the mth antenna panel.

Moreover, Ry is a code rate of a yth antenna panel, and Qmy is a modulation order of the yth antenna panel.

Moreover, m is a positive integer less than or equal to M.

In summary, a frequency domain resource number occupied by the mth antenna panel is Ratio_m2*N_rb.

In an example, two antenna panels are arranged at the terminal. Wave beam directions corresponding to the two antenna panels include: a first wave beam direction and a second wave beam direction.

Ratio coefficient Ratio_1 of the first wave beam direction is: Ratio_1=R1*Qm1/(R2*Qm2); and

ratio coefficient Ratio_2 of the second wave beam direction is: Ratio_2=R2*Qm2/(R1*Qm1).

In some examples, a serial number of a frequency domain resource corresponding to the first wave beam direction is [0, floor(N_rb/1+Ratio_1)−1], and a serial number of a frequency domain resource occupied by a second antenna panel is (floor(N_rb/(1+Ratio_1)−1, N_rb];
and alternatively,
a serial number of a frequency domain resource corresponding to the second wave beam direction is [0, floor(N_rb/(1+Ratio_2)−1], and a serial number of a frequency domain resource occupied by a first antenna panel is (floor(N_rb/(1+Ratio_2)−1, N_rb].

In some examples, frequency domain resources for the terminal are divided by M_rb and have serial numbers of 0 to ceil(N_rb/M_rb).

A serial number of a frequency domain resource corresponding to the first wave beam direction is [0, ceil((Ratio_1/(Ratio_1+Ratio_2)*ceil(N_rb/M_rb))], and a serial number of a frequency domain resource corresponding to a second wave beam direction is (ceil((Ratio_1/(Ratio_1+Ratio_2)*ceil(N_rb/M_rb)), ceil(N_rb/M_rb)];
and alternatively,
a serial number of a frequency domain resource corresponding to the second wave beam direction is [0, ceil((Ratio_2/(Ratio_1+Ratio_2)*ceil(N_rb/M_rb))], and a serial number of a frequency domain resource corresponding to the first wave beam direction is (ceil((Ratio_2/(Ratio_1+Ratio_2)*ceil(N_rb/M_rb)), ceil(N_rb/M_rb)].

Specifically, ceil ( ) represents rounding up a value in the brackets.

In an example of the disclosure, serial numbers of all frequency domain resources are indexes of the frequency domain resources.

In some examples, one transmission block for the PUSCH transmission corresponds to one code word (CW) or partial information of one code word.

In some examples, the one code word corresponds to one MCS indication field or a plurality of MCS indication fields.

The one MCS indication field indicates an MCS used by one antenna panel.

Scheduling information of one TB may include an MCS indication field, which indicates an MCS adopted by the TB. If one TB is transmitted by a plurality of panels of the terminal, an MCS indication field included in scheduling information of the TB may simultaneously indicate an MC used by a plurality of antenna panels of the terminal. For instance, in the one MCS indication field, each code point corresponds to a combination of MCSs of a plurality of antenna panels simultaneously.

In another example, scheduling information of a TB may include a plurality of MCS indication fields. A number of MCS indication fields included is equal to a number of the antenna panels of the terminal. Illustratively, the terminal is provided with two antenna panels. Scheduling information of one TB may include two MCS indication fields. In this case, one MCS indication field indicates an MCS of one antenna panel.

In an example, a coordination parameter for a plurality of antenna panels of the terminal to perform the PUSCH transmission by using the same frequency domain resource number is determined by adopting the first strategy. In this case, the MCSs used by a plurality of antenna panels are the same. Thus, if scheduling information of one TB has a plurality of MCS fields, a single MCS indication field may be used to indicate the MCS. In a case that at least one of the plurality of MCS indication fields carries a predetermined bit value, it is indicated that the second strategy is not supported.

For instance, the predetermined bit value may be all “0” bits or “1” bits.

In some examples, whether the second strategy is supported when the plurality of antenna panels of the terminal transmit the PUSCH transmission by using the wave beams is indicated by a high-layer signaling.

The high-layer signaling includes but is not limited to a medium access control control element (MAC CE)/or radio resource control (RRC) signaling.

The base station may indicate whether the second strategy is currently supported by means of the high-layer signaling.

In some examples, if no high-layer signaling indicating that the second strategy is supported is received, it can be considered that the first strategy is supported by default.

Such a method of additionally indicating, by means of a high-layer signaling, whether the second strategy is supported is applicable to a case that scheduling information of one TB includes only one MCS indication field.

In some examples, the PUSCH transmission includes one of the following:
scheduling-free uplink transmission; and
uplink transmission scheduled by single downlink control information (DCI).

For instance, the scheduling-free uplink transmission may include but is not limited to configured grant (CG) uplink transmission. Illustratively, such scheduling-free uplink transmission includes but is not limited to CG-PUSCH transmission. Specifically, the scheduling-free CG-PUSCH may include but is not limited to CG-PUSCH type 1 and CG-PUSCH type 2.

In some examples, the PUSCH type of the PUSCH transmission includes at least one of the following:
the PUSCH scheduled by the single-DCI (S-DCI);
scheduling-free CG PUSCH type 1; and
scheduling-free CG PUSCH type 2.

In an example, FDRA information of the different antenna panels is carried by one FDRA domain;
and alternatively,

FDRA information of the different antenna panels is carried by different FDRA domains.

The FDRA information may be included in scheduling information of the TB. The scheduling information of the TB may include an FDRA domain. The FDRA domain may be used to exclusively carry the FDRA information.

In an example, the scheduling information of the TB may include an FDRA field. The FDRA field uniformly indicates frequency domain resources for a plurality of antenna panels (for instance, two antenna panels) of the terminal. In another example, the scheduling information of the TB may include a plurality of FDRA domains. A number of the FDRA domains is equal to a number of antenna panels of the terminal. In this case, one FDRA domain carries scheduling information of a frequency domain resource of one antenna panel.

In an example, the first wave beam direction corresponds to a wave beam direction of a first antenna panel of the terminal, or a wave beam direction of transmitting a PUCCH to a first TRP of the base station.

The second wave beam direction corresponds to a wave beam direction of a second antenna panel of the terminal, or a wave beam direction of transmitting a PUCCH to a second TRP of the base station.

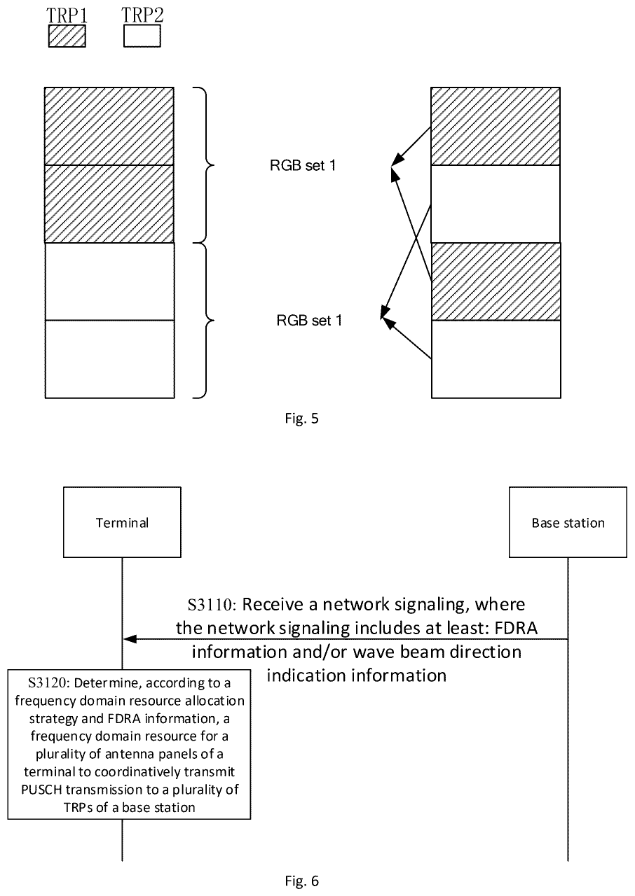

As shown in FIG. 6, an example of the disclosure provides a method for determining a frequency domain resource. The method is executed by a terminal and may include:

S3110: A network signaling is received. The network signaling includes at least: FDRA information and/or wave beam direction indication information.

S3120: According to a frequency domain resource allocation strategy and FDRA information of a terminal, the frequency domain resource for a plurality of antenna panels of the terminal to coordinatively transmit PUSCH transmission to a plurality of TRPs of a base station is determined.

The antenna panels transmit the PUSCH transmission by using wave beams. Directions of the wave beams used by different antenna panels are indicated by wave beam direction indication information. The wave beam direction indication information includes: transmission configuration indication (TCI) or a source indication parameter of a sounding reference signal (SRS).

In an example, the frequency domain resource allocation strategy may also be indicated by the scheduling information of the TB or determined according to protocol conventions.

The network signaling includes but is not limited to an RRC signaling, an MAC CE signaling, and/or DCI.

In an example, the frequency domain resource allocation strategy includes:
a first strategy indicating that numbers of frequency domain resources used for the PUSCH transmission from the different antenna panels to the plurality of transmission reception points (TRPs) of the base station are balanced;
or
a second strategy indicating that numbers of frequency domain resources used by the different antenna panels are determined according to channel state information between the different antenna panels and the TRPs.

In an example, frequency domain resources corresponding to one antenna panel are continuously distributed in the frequency domain;
and alternatively,
the frequency domain resources used by the different antenna panels are distributed in a staggered manner in a predetermined frequency domain resource unit in the frequency domain.

In an example, the predetermined frequency domain resource unit includes:
one RB;
or
one resource block group (RBG). One RBG includes one or more RBs.

In an example, the frequency domain resource allocation strategy is the first strategy. Two antenna panels are arranged at the terminal. Wave beam directions corresponding to the two antenna panels include a first wave beam direction and a second wave beam direction.

A serial number of a frequency domain resource corresponding to the first wave beam direction is [0, floor(N_rb/2)−1], and a serial number of a frequency domain resource corresponding to the second wave beam direction is (floor(N_rb*/2)−1, N_rb];
and alternatively,
a serial number of a frequency domain resource corresponding to the second wave beam direction is [0, floor(N_rb/2)−1], and a serial number of a frequency domain resource corresponding to the first wave beam direction of the terminal is (floor(N_rb*/2)−1, floor(N_rb*/2)−1].

Specifically, N_rb is a total number of frequency domain resources indicated by the frequency domain resource allocation (FDRA) information.

In an example, the frequency domain resource allocation strategy is the first strategy. Two antenna panels are arranged at the terminal. Wave beam directions corresponding to the two antenna panels include a first wave beam direction and a second wave beam direction.

A serial number of a frequency domain resource corresponding to the first wave beam direction is an odd number, and a serial number of a frequency domain resource corresponding to the second wave beam direction is an even number;
and alternatively,
a serial number of a frequency domain resource corresponding to the first wave beam direction is an even number, and a serial number of a frequency domain resource corresponding to the second wave beam direction is an odd number.

In an example, the channel state information includes at least: a channel quality indicator (CQI).

In an example, modulation and coding schemes (MCSs) used by different types of channel state information are different. Code rates and/or modulation orders of the different MCSs are different.

In an example, the frequency domain resource allocation strategy is the second strategy. The numbers of the frequency domain resources for the antenna panels are determined according to a ratio coefficient.

The ratio coefficient is determined according to code rates and modulation orders for the antenna panels of the terminal to perform the PUSCH transmission.

In an example, two antenna panels are arranged at the terminal. Wave beam directions corresponding to the two antenna panels include: a first wave beam direction and a second wave beam direction.

Ratio coefficient Ratio_1 corresponding to the first wave beam direction is: Ratio_1=R1*Qm1/(R2*Qm2); and

ratio coefficient Ratio_2 corresponding to the second wave beam direction is: Ratio_2=R2*Qm2/(R1*Qm1).

In an example, a serial number of a frequency domain resource corresponding to the first wave beam direction is [0, floor(N_rb/1+Ratio_1)−1], and a serial number of a frequency domain resource occupied by a second antenna panel is (floor(N_rb/(1+Ratio_1)−1, N_rb];
and alternatively,
a serial number of a frequency domain resource corresponding to the second wave beam direction is [0, floor(N_rb/(1+Ratio_2)−1], and a serial number of a frequency domain resource occupied by a first antenna panel is (floor(N_rb/(1+Ratio_2)−1, N_rb].

In an example, frequency domain resources for the terminal are divided by M_rb and have serial numbers of 0 to ceil(N_rb/M_rb).

A serial number of a frequency domain resource corresponding to the first wave beam direction is [0, ceil((Ratio_1/(Ratio_1+Ratio_2)*ceil(N_rb/M_rb))], and a serial number of a frequency domain resource occupied by a second antenna panel is (ceil((Ratio_1/(Ratio_1+Ratio_2)*ceil(N_rb/M_rb)), ceil(N_rb/M_rb)];
and alternatively,
a serial number of a frequency domain resource corresponding to the second wave beam direction is [0, ceil((Ratio_2/(Ratio_1+Ratio_2)*ceil(N_rb/M_rb))], and a serial number of a frequency domain resource occupied by a first antenna panel is (ceil((Ratio_2/(Ratio_1+Ratio_2)*ceil(N_rb/M_rb)), ceil(N_rb/M_rb)].

In an example, one transmission block for the PUSCH transmission corresponds to one code word (CW) or partial information of one code word.

In an example, the one code word corresponds to one MCS indication field or a plurality of MCS indication fields.

The one MCS indication field indicates an MCS used by one antenna panel.

In an example, in a case that at least one of the plurality of MCS indication fields carries a predetermined bit value, it is indicated that the second strategy is not supported.

In an example, whether the second strategy is supported when the plurality of antenna panels of the terminal transmit the PUSCH transmission by using the wave beams is indicated by a high-layer signaling.

In an example, the PUSCH transmission includes one of the following:
scheduling-free uplink transmission; and
uplink transmission scheduled by single downlink control information (DCI).

In an example, the PUSCH type of the PUSCH transmission includes at least one of the following:
the PUSCH scheduled by the S-DCI;
scheduling-free CG PUSCH type 1; and
scheduling-free CG PUSCH type 2.

In an example, FDRA information of the different antenna panels is carried by one FDRA domain;
and alternatively,
FDRA information of the different antenna panels is carried by different FDRA domains.

In an example, the first wave beam direction corresponds to a wave beam direction of a first antenna panel of the terminal, or a wave beam direction of transmitting a PUCCH to a first TRP of the base station.

The second wave beam direction corresponds to a wave beam direction of a second antenna panel of the terminal, or a wave beam direction of transmitting a PUCCH to a second TRP of the base station.

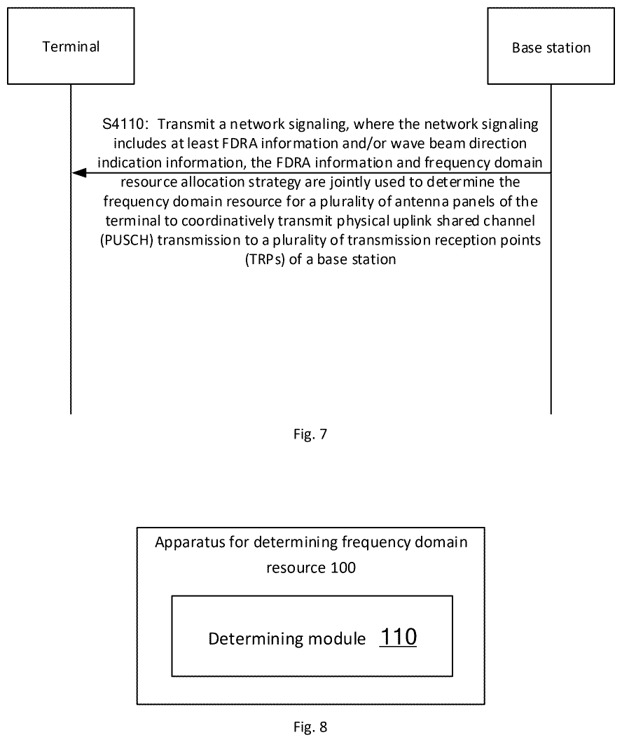

As shown in FIG. 7, an example of the disclosure provides a method for determining a frequency domain resource. The method is executed by a base station and may include:

S4110: A network signaling is transmitted. The network signaling includes at least FDRA information and/or wave beam direction indication information. The FDRA information and frequency domain resource allocation strategy are jointly used to determine the frequency domain resource for a plurality of antenna panels of the terminal to coordinatively transmit physical uplink shared channel (PUSCH) transmission to a plurality of transmission reception points (TRPs) of a base station.

The antenna panels transmit the PUSCH transmission by using wave beams. Directions of the wave beams used by different antenna panels are indicated by wave beam direction indication information. The wave beam direction indication information includes: transmission configuration indication (TCI) or a source indication parameter of a sounding reference signal (SRS).

In an example, the frequency domain resource allocation strategy may also be indicated by the scheduling information of the TB or determined according to protocol conventions.

The network signaling includes but is not limited to an RRC signaling, an MAC CE signaling, and/or DCI.

In an example, the frequency domain resource allocation strategy includes:
a first strategy indicating that numbers of frequency domain resources used for the PUSCH transmission from the different antenna panels to the plurality of transmission reception points (TRPs) of the base station are balanced;
or
a second strategy indicating that numbers of frequency domain resources used by the different antenna panels are determined according to channel state information between the different antenna panels and the TRPs.

In an example, frequency domain resources corresponding to one antenna panel are continuously distributed in the frequency domain;
and alternatively,
the frequency domain resources used by the different antenna panels are distributed in a staggered manner in a predetermined frequency domain resource unit in the frequency domain.

In an example, the predetermined frequency domain resource unit includes:
one RB;
or
one resource block group (RBG). One RBG includes one or more RBs.

In an example, the frequency domain resource allocation strategy is the first strategy. Two antenna panels are arranged at the terminal. Wave beam directions corresponding to the two antenna panels include a first wave beam direction and a second wave beam direction.

A serial number of a frequency domain resource corresponding to the first wave beam direction is [0, floor(N_rb/2)−1], and a serial number of a frequency domain resource corresponding to the second wave beam direction is (floor(N_rb*/2)−1, N_rb];
and alternatively,
a serial number of a frequency domain resource corresponding to the second wave beam direction is [0, floor(N_rb/2)−1], and a serial number of a frequency domain resource corresponding to the first wave beam direction of the terminal is (floor(N_rb*/2)−1, N_rb].

Specifically, N_rb is a total number of frequency domain resources indicated by the frequency domain resource allocation (FDRA) information.

In an example, the frequency domain resource allocation strategy is the first strategy. Two antenna panels are arranged at the terminal. Wave beam directions corresponding to the two antenna panels include a first wave beam direction and a second wave beam direction.

A serial number of a frequency domain resource corresponding to the first wave beam direction is an odd number, and a serial number of a frequency domain resource corresponding to the second wave beam direction is an even number;
and alternatively,
a serial number of a frequency domain resource corresponding to the first wave beam direction is an even number, and a serial number of a frequency domain resource corresponding to the second wave beam direction is an odd number.

In an example, the channel state information includes at least: a channel quality indicator (CQI).

In an example, modulation and coding schemes (MCSs) used by different types of channel state information are different. Code rates and/or modulation orders of the different MCSs are different.

In an example, the frequency domain resource allocation strategy is the second strategy. The numbers of the frequency domain resources for the antenna panels are determined according to a ratio coefficient.

The ratio coefficient is determined according to code rates and modulation orders for the antenna panels of the terminal to perform the PUSCH transmission.

In an example, two antenna panels are arranged at the terminal. Wave beam directions corresponding to the two antenna panels include: a first wave beam direction and a second wave beam direction.

Ratio coefficient Ratio_1 corresponding to the first wave beam direction is: Ratio_1=R1*Qm1/(R2*Qm2); and

ratio coefficient Ratio_2 corresponding to the second wave beam direction is: Ratio_2=R2*Qm2/(R1*Qm1).

In an example, a serial number of a frequency domain resource corresponding to the first wave beam direction is [0, floor(N_rb/1+Ratio_1)−1], and a serial number of a frequency domain resource occupied by a second antenna panel is (floor(N_rb/(1+Ratio_1)−1, N_rb];
and alternatively,
a serial number of a frequency domain resource corresponding to the second wave beam direction is [0, floor(N_rb/(1+Ratio_2)−1], and a serial number of a frequency domain resource occupied by a first antenna panel is (floor(N_rb/(1+Ratio_2)−1, N_rb].

In an example, frequency domain resources for the terminal are divided by M_rb and have serial numbers of 0 to ceil(N_rb/M_rb).

A serial number of a frequency domain resource corresponding to the first wave beam direction is [0, ceil((Ratio_1/(Ratio_1+Ratio_2)*ceil(N_rb/M_rb))], and a serial number of a frequency domain resource occupied by a second antenna panel is (ceil((Ratio_1/(Ratio_1+Ratio_2)*ceil(N_rb/M_rb)), ceil(N_rb/M_rb)];
and alternatively,
a serial number of a frequency domain resource corresponding to the second wave beam direction is [0, ceil((Ratio_2/(Ratio_1+Ratio_2)*ceil(N_rb/M_rb))], and a serial number of a frequency domain resource occupied by a first antenna panel is (ceil((Ratio_2/(Ratio_1+Ratio_2)*ceil(N_rb/M_rb)), ceil(N_rb/M_rb)].

In an example, one transmission block for the PUSCH transmission corresponds to one code word (CW) or partial information of one code word.

In an example, the one code word corresponds to one MCS indication field or a plurality of MCS indication fields.

The one MCS indication field indicates an MCS used by one antenna panel.

In an example, in a case that at least one of the plurality of MCS indication fields carries a predetermined bit value, it is indicated that the second strategy is not supported.

In an example, whether the second strategy is supported when the plurality of antenna panels of the terminal transmit the PUSCH transmission by using the wave beams is indicated by a high-layer signaling.

In an example, the PUSCH transmission includes one of the following:
scheduling-free uplink transmission; and
uplink transmission scheduled by single downlink control information (DCI).

In an example, the PUSCH type of the PUSCH transmission includes at least one of:
the PUSCH scheduled by the S-DCI;
scheduling-free CG PUSCH type 1; and
scheduling-free CG PUSCH type 2.

In an example, FDRA information of the different antenna panels is carried by one FDRA domain;
and alternatively,
FDRA information of the different antenna panels is carried by different FDRA domains.

In an example, the first wave beam direction corresponds to a wave beam direction of a first antenna panel of the terminal, or a wave beam direction of transmitting a PUCCH to a first TRP of the base station.

The second wave beam direction corresponds to a wave beam direction of a second antenna panel of the terminal, or a wave beam direction of transmitting a PUCCH to a second TRP of the base station.

An example of the disclosure mainly solves a frequency domain resource allocation method in an uplink FDM multiplexing mode based on a plurality of antenna panels/TRPs. The specific method is as follows:
according to a FDM solution based on single-DCI, one TB corresponds to L transmission layers. Illustratively, L is less than or equal to 4. For instance, if the plurality of antenna panels use coherent-joint transmission (C-JT), L may be a less value than a maximum number of transmission layers supported by the two antenna panels of the terminal. If a plurality of antenna panels use uncorrelated-joint transmission (NC-JT), L may be a maximum number of transmission layers supported by each of the two antenna panels of the terminal.

Frequency domain resources indicated by the FDRA domain are uplink resources for the terminal on a terminal active bandwidth part (BWP). It is required to determine frequency domain resources specifically occupied for associating different plurality of antenna panels/TRPs.

### Mode 1:

in a case that resources are evenly allocated, for an indicated group of RBs/RBGs, a corresponding number of RBs is N_rb, and this solution is applicable to PUSCH transmission.
1-1: Half-half allocation.

An RB/PRG set occupied by TRP1 is [0, floor(N_rb/2)−1], and the others are RBs corresponding to TRP2;
and alternatively,
an RB/PRG set occupied by TRP2 is [0, floor(N_rb/2)−1], and the others are RBs corresponding to TRP1.
1-2:
N_rb is grouped according to PRB granularity M_rb, indexes corresponding RB sets are 0, 1, . . . , ceil(N_rb/M-rb) respectively, and then alternate resource allocation is performed on these groups.

Specifically, TRP1 occupies resource groups of even number indexes, and TRP2 occupies resource groups of odd number indexes;
and alternatively,
TRP1 occupies resource groups of odd number indexes, and TRP2 occupies resource indexes of even number indexes.

### Mode 2:

in a case that resources are flexibly allocated, for an indicated group of RBs/RBGs, a corresponding number of RBs is N_rb, and this solution is applicable to PUSCH transmission.

After the base station confirms that the FDM solution (RRC, MAC-CE or other DCI indication) is used, the second MCS indication field estimated and configured by the CQI obtained by the base station on the basis of different TRPs is read. If the second MCS indication field is a special indication such as all 0, it is indicated that the flexible resource allocation scheme is not supported.

In a case that flexible allocation is supported, R1 and Qm1 corresponding to MCS1 of TRP1, and R2 and Qm2 corresponding to MCS2 of TRP2 are further computed to obtain a ratio coefficient, such as X_ratio=R2*Qm2/(R1*Qm1).
2-1: TRP resources are continuously allocated relative to resources indicated by the FDRA.

An RB/PRG set occupied by TRP1 is [0, floor(N_rb/(1+X_ratio))−1], and the others are RBs corresponding to TRP2;
and alternatively,
an RB/PRG set occupied by TRP2 is [0, floor(N_rb/(1+X_ratio))−1], and the others are RBs corresponding to TRP1.
2-2: N_rb is grouped according to PRB granularity M_rb, indexes corresponding to RB sets are 0, 1 . . . , ceil(N_rb/M-rb) respectively, and then unbalanced resource allocation is performed on these groups with reference to X_ratio, for instance, 1/(1+X_ratio)=Z/Y.

Starting from an actual RB set, corresponding to resource groups of Y consecutive RBs, TRP1 occupies resource groups of first Z indexes in groups, TRP2 occupies resource groups of next (Y-Z) indexes, and the other RB sets are allocated according to the allocation ratio.

The RB set here may be the above predetermined frequency domain resource unit.

As shown in FIG. 8, an example of the disclosure provides an apparatus for determining a frequency domain resource 100. The apparatus includes:
a determining module 110 configured to determine, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station.

The antenna panels transmit the PUSCH transmission by using wave beams. Directions of the wave beams used by different antenna panels are indicated by wave beam direction indication information. The wave beam direction indication information includes: transmission configuration indication (TCI) or a source indication parameter of a sounding reference signal (SRS).

In some examples, the apparatus for determining a frequency domain resource 100 may be included in a terminal or a base station.

The apparatus for determining a frequency domain resource 100 may further include a storage module. The storage module may be configured to store at least FDRA information and/or wave beam direction indication information.

In some examples, the frequency domain resource allocation strategy includes:
a first strategy indicating that numbers of frequency domain resources used for the PUSCH transmission from the different antenna panels to the plurality of transmission reception points (TRPs) of the base station are balanced;
or
a second strategy indicating that numbers of frequency domain resources used by the different antenna panels are determined according to channel state information between the different antenna panels and the TRPs.

In some examples, frequency domain resources corresponding to one antenna panel are continuously distributed in the frequency domain;
and alternatively,
the frequency domain resources used by the different antenna panels are distributed in a staggered manner in a predetermined frequency domain resource unit in the frequency domain.

In some examples, the predetermined frequency domain resource unit includes:
one RB;
or
one resource block group (RBG). One RBG includes one or more RBs.

In some examples, the frequency domain resource allocation strategy is the first strategy. Two antenna panels are arranged at the terminal. Wave beam directions corresponding to the two antenna panels includes a first wave beam direction and a second wave beam direction respectively.

A serial number of a frequency domain resource corresponding to the first wave beam direction of the terminal is [0, floor(N_rb/2)−1], and a serial number of a frequency domain resource corresponding to the second wave beam direction is (floor(N_rb*/2)−1, N_rb];
and alternatively,
a serial number of a frequency domain resource corresponding to the second wave beam direction is [0, floor(N_rb/2)−1], and a serial number of a frequency domain resource corresponding to the first wave beam direction of the terminal is (floor(N_rb*/2)−1, N_rb].

Specifically, N_rb is a total number of frequency domain resources indicated by the frequency domain resource allocation (FDRA) information.

In some examples, the frequency domain resource allocation strategy is the first strategy. Two antenna panels are arranged at the terminal. Wave beam directions corresponding to the two antenna panels includes a first wave beam direction and a second wave beam direction.

A serial number of a frequency domain resource corresponding to the first wave beam direction is an odd number, and a serial number of a frequency domain resource corresponding to the second wave beam direction is an even number;
and alternatively,
a serial number of a frequency domain resource corresponding to the first wave beam direction is an even number, and a serial number of a frequency domain resource corresponding to the second wave beam direction is an odd number.

In some examples, the channel state information includes at least: a channel quality indicator (CQI).

In some examples, modulation and coding schemes (MCSs) used by different types of channel state information are different. Code rates and/or modulation orders of the different MCSs are different.

In some examples, the frequency domain resource allocation strategy is the second strategy. The numbers of the frequency domain resources for the antenna panels are determined according to a ratio coefficient.

The ratio coefficient is determined according to code rates and modulation orders for the antenna panels of the terminal to perform the PUSCH transmission.

In some examples, two antenna panels are arranged at the terminal. Wave beam directions corresponding to the two antenna panels include: a first wave beam direction and a second wave beam direction.

Ratio coefficient Ratio_1 corresponding to the first wave beam direction is: Ratio_1=R1*Qm1/(R2*Qm2); and
ratio coefficient Ratio_2Ratio_2 corresponding to the second wave beam direction is:

$$Ratio\_ 2 = R 2 * Qm 2 / ( R 1 * Qm 1 ) .$$

In some examples, a serial number of a frequency domain resource corresponding to the first wave beam direction is [0, floor(N_rb/1+Ratio_1)−1], and a serial number of a frequency domain resource occupied by a second antenna panel is (floor(N_rb/(1+Ratio_1)−1, N_rb];
and alternatively,
a serial number of a frequency domain resource corresponding to the second wave beam direction is [0, floor(N_rb/(1+Ratio_2)−1], and a serial number of a frequency domain resource occupied by a first antenna panel is (floor(N_rb/(1+Ratio_2)−1, N_rb].

In some examples, frequency domain resources for the terminal are divided by M_rb and have serial numbers of 0 to ceil(N_rb/M_rb).

A serial number of a frequency domain resource corresponding to the first wave beam direction is [0, ceil((Ratio_1/(Ratio_1+Ratio_2)*ceil(N_rb/M_rb))], and a serial number of a frequency domain resource occupied by a second antenna panel is (ceil((Ratio_1/(Ratio_1+Ratio_2)*ceil(N_rb/M_rb)), ceil(N_rb/M_rb)];
and alternatively,
a serial number of a frequency domain resource corresponding to the second wave beam direction is [0, ceil((Ratio_2/(Ratio_1+Ratio_2)*ceil(N_rb/M_rb))], and a serial number of a frequency domain resource occupied by a first antenna panel is (ceil((Ratio_2/(Ratio_1+Ratio_2)*ceil(N_rb/M_rb)), ceil(N_rb/M_rb)].

In some examples, one transmission block for the PUSCH transmission corresponds to one code word (CW) or partial information of one code word.

In some examples, the one code word corresponds to one MCS indication field or a plurality of MCS indication fields.

The one MCS indication field indicates an MCS used by one antenna panel.

In some examples, in a case that at least one of the plurality of MCS indication fields carries a predetermined bit value, it is indicated that the second strategy is not supported.

In some examples, whether the second strategy is supported when the plurality of antenna panels of the terminal transmit the PUSCH transmission by using the wave beams is indicated by a high-layer signaling.

In some examples, the PUSCH transmission includes one of the following:
scheduling-free uplink transmission; and
uplink transmission scheduled by single downlink control information (DCI).

In some examples, the PUSCH type of the PUSCH transmission includes at least one of the following:
the PUSCH scheduled by the S-DCI;
scheduling-free CG PUSCH type 1; and
scheduling-free CG PUSCH type 2.

In some examples, FDRA information of the different antenna panels is carried by one FDRA domain;
and alternatively,
FDRA information of the different antenna panels is carried by different FDRA domains.

In some examples, the first wave beam direction corresponds to a wave beam direction of a first antenna panel of the terminal, or a wave beam direction of transmitting a PUCCH to a first TRP of the base station.

The second wave beam direction corresponds to a wave beam direction of a second antenna panel of the terminal, or a wave beam direction of transmitting a PUCCH to a second TRP of the base station.

An example of the disclosure provides a communication device. The communication device includes:
a memory for storing a processor-executable instruction; and
a processor connected to the memory.

The processor is configured to execute the method for determining a frequency domain resource provided in any one of the above technical solutions.

The processor may include various types of storage media. The storage medium is a non-transitory computer storage medium that may keep memorizing information stored after the communication device is powered off.

The communication device here includes a terminal or a base station.

The processor may be connected to the memory by means of a bus, etc., and is configured to read executable programs stored in the memory, such as at least one of the methods shown in FIG. 2, 4, 6 or 7.

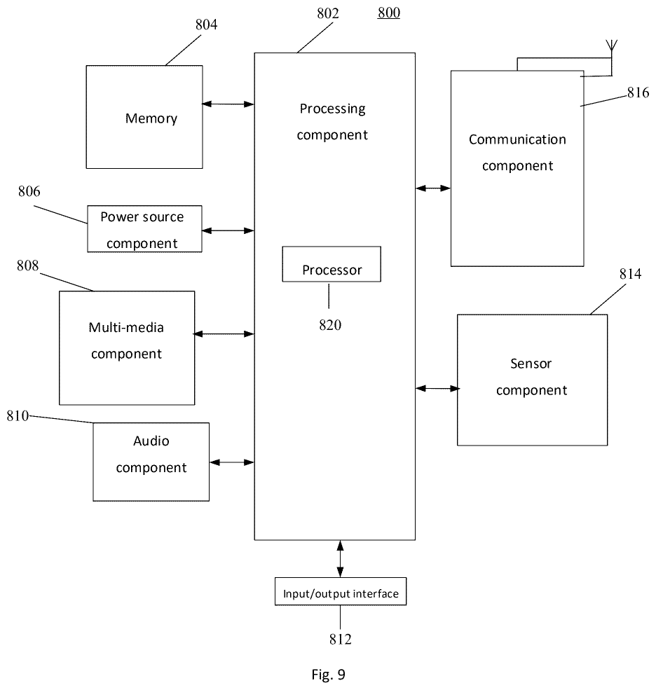

FIG. 9 is a block diagram of a terminal 800 shown according to an example. For instance, the terminal 800 may be a mobile phone, a computer, a digital broadcasting user device, a message receiving and transmitting device, a game console, a tablet device, a medical device, a fitness device, a personal digital assistant, etc.

With reference to FIG. 9, the terminal 800 may include one or more of components as follows: a processing component 802, a memory 804, a power source component 806, a multi-media component 808, an audio component 810, an input/output (I/O) interface 812, a sensor component 814, and a communication component 816.

The processing component 802 generally controls overall operation of the terminal 800, such as operations associated with display, telephone call, data communication, camera operation and recording. The processing component 802 may include one or more processors 820 to execute an instruction, so as to implement all or some steps of the above method. In addition, the processing component 802 may include one or more modules such that the processing component 802 can interact with other components. For instance, the processing component 802 may include a multi-media module such that the multi-media component 808 can interact with the processing component 802.

The memory 804 is configured to store various types of data, so as to support operations at the terminal 800. Instances of such data include instructions for any application or method operating on the terminal 800, contact data, phonebook data, messages, pictures, videos, etc. The memory 804 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power source component 806 provides power for various components of the terminal 800. The power source component 806 may include a power source management system, one or more power sources, and other components associated with generation, management and power distribution for the terminal 800.

The multi-media component 808 includes a screen that provides an output interface between the terminal 800 and a user. In some examples, the screen may include a liquid crystal display (LCD) and a touch panel (TP). If the screen includes a touch panel, the screen can be implemented as a touch screen to receive an input signal from a user. The touch panel includes one or more touch sensors to sense a touch, a swipe and a gesture on the touch panel. The touch sensor can not only sense a boundary of a touch or a swipe, but also measure duration and pressure associated with the touch or the swipe. In some examples, the multi-media component 808 includes a front-facing camera and/or a rear-facing camera. When the terminal 800 is in an operating mode, such as a shooting mode or a video mode, the front-facing camera and/or the rear-facing camera may receive external multi-media data. Each of the front-facing camera and the rear-facing camera may be a fixed optical lens system or have focusing and optical zooming capabilities.

The audio component 810 is configured to output and/or input an audio signal. For instance, the audio component 810 may include a microphone (MIC). When the terminal 800 is in an operating mode, such as a call mode, a recording mode, and a voice recognition mode, the microphone is configured to receive external audio signals. The received audio signal may be further stored in the memory 804 or transmitted by means of the communication component 816. In some examples, the audio component 810 further includes a loudspeaker configured to output an audio signal.

The I/O interface 812 provides an interface between the processing component 802 and peripheral interface modules, such as keyboards, click wheels and buttons. These buttons may include but are not limited to a home button, a volume button, a start button and a lock button.

The sensor component 814 may include one or more sensors for providing status assessment of various aspects of the terminal 800. For instance, the sensor component 814 may detect an open/closed state of the terminal 800, and relative positioning of components, such as, a display and keypad of the terminal 800. The sensor component 814 may further detect a change in position of the terminal 800 or a component of the terminal 800, presence or absence of contact between a user and the terminal 800, orientation or acceleration/deceleration of the terminal 800, and a temperature change of the terminal 800. The sensor component 814 may include a proximity sensor, which is configured to detect the presence of a nearby object in the absence of any physical touch. The sensor component 814 may further include a light sensor, such as a complementary metal oxide semiconductor (CMOS) or charge coupled device (CCD) image sensor, which are configured to be used in imaging applications. In some examples, this sensor component 814 may further include an acceleration sensor, a gyroscopic sensor, a magnetic sensor, a pressure sensor or a temperature sensor.

The communication component 816 is configured to facilitate wired or wireless communication between the terminal 800 and other devices. The terminal 800 may access a wireless network based on a communication standard, such as Wi-Fi, 2G, 3G, or their combinations. In an example, the communication component 816 receives a broadcast signal or broadcast related information from an external broadcast management system by means of a broadcast channel. In an example, the communication component 816 further includes a near-field communication (NFC) module to promote short-range communication. For instance, the NFC module may be implemented on the basis of a radio frequency identification (RFID) technology, an infrared data association (IrDA) technology, an ultra wideband (UWB) technology, a Bluetooth (BT) technology and other technologies.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, and is configured to execute the above methods.

An example provides a non-transitory computer-readable storage medium including an instruction, such as a memory 804 including an instruction. The above instruction may be executed by the processor 820 of the terminal 800, so as to implement the above method. For instance, the non-transitory computer-readable storage medium may be an ROM, a random access memory (RAM), a compact disc read-only memory (CD-ROM), a magnetic tape, a floppy disk or an optical data storage device, etc.

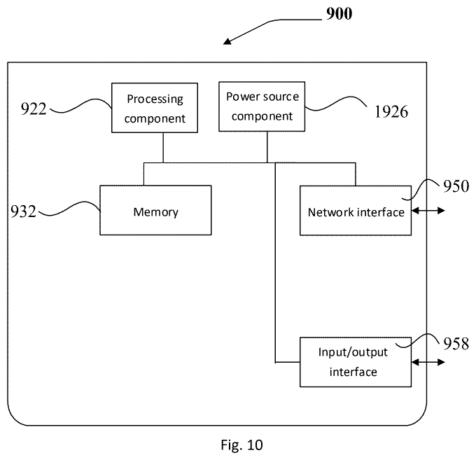

As shown in FIG. 10, an example of the disclosure provides a structure of a communication device 900. For instance, the communication device 900 may be provided as a network-side device. The communication device 900 may be the above base station.

With reference to FIG. 10, the communication device 900 includes a processing component 922. The processing component further includes one or more processors, and memory resources represented by the memory 932, and is configured to store an instruction which can be executed by the processing component 922, such as an application. The application stored in the memory 932 may include one or more modules which each corresponds to a group of instructions. In addition, the processing component 922 is configured to execute an instruction, so as to execute any above method applied to the base station, such as at least one of the methods shown in FIG. 2, 4, 6 or 7.

The communication device 900 may further include a power source component 926 configured to execute power source management for the communication device 900, a wired or wireless network interface 950 configured to connect the communication device 900 to a network, and an input/output (I/O) interface 958. The communication device 900 may operate an operating system stored in the memory 932, such as Windows Server™, Mac OS X™, Unix™, Linux™, FreeBSD™ and similar systems.

A person skilled in the art could easily conceive of other implementation solutions of the disclosure upon consideration of the description and the disclosure disclosed in the implementation. The disclosure is intended to cover any variations, uses or adaptive changes of the disclosure, which follow the general principles of the disclosure and include common general knowledge or customary technical means, which is not disclosed in the disclosure, in the art. The description and examples are to be regarded as illustrative merely, and the true scope and spirit of the disclosure are indicated by the following claims.

It should be understood that the disclosure is not limited to a precise structure that is described above and illustrated in accompanying drawings, and can have various modifications and changes without departing from the scope of the disclosure. The scope of the disclosure is limited by the appended claims merely.

1. A method for determining a frequency domain resource, the method comprising:
determining, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station; wherein
the antenna panels transmit the PUSCH transmission by using wave beams, directions of the wave beams used by different antenna panels are indicated by wave beam direction indication information, and the wave beam direction indication information comprises: transmission configuration indication (TCI) or a source indication parameter of a sounding reference signal (SRS).

2. The method according to claim 1, wherein the frequency domain resource allocation strategy comprises:
a first strategy indicating that numbers of frequency domain resources used for the PUSCH transmission from the different antenna panels to the plurality of transmission reception points (TRPs) of the base station are balanced;
or
a second strategy indicating that numbers of frequency domain resources used by the different antenna panels are determined according to channel state information between the different antenna panels and the TRPs.

3. The method according to claim 2, wherein
frequency domain resources corresponding to one antenna panel are continuously distributed in a frequency domain;
and alternatively,
the frequency domain resources used by the different antenna panels are distributed in a staggered manner in a predetermined frequency domain resource unit in the frequency domain.

4. The method according to claim 3, wherein the predetermined frequency domain resource unit comprises:
one resource block (RB);
or
one resource block group (RBG); wherein one RBG comprises one or more RBs.

5. The method according to claim 2, wherein the frequency domain resource allocation strategy is the first strategy, two antenna panels are arranged at the terminal, and wave beam directions corresponding to the two antenna panels are a first wave beam direction and a second wave beam direction respectively;
a serial number of a frequency domain resource corresponding to the first wave beam direction is [0, floor(N_rb/2)−1], and a serial number of a frequency domain resource corresponding to the second wave beam direction is (floor(N_rb*/2)−1, N_rb];
and alternatively,
a serial number of a frequency domain resource corresponding to the second wave beam direction is [0, floor(N_rb/2)−1], and a serial number of a frequency domain resource corresponding to the first wave beam direction is (floor(N_rb*/2)−1, N_rb]; wherein
N_rb is a total number of frequency domain resources indicated by the frequency domain resource allocation (FDRA) information.

6. The method according to claim 2, wherein the frequency domain resource allocation strategy is the first strategy, two antenna panels are arranged at the terminal, and wave beam directions corresponding to the two antenna panels are a first wave beam direction and a second wave beam direction respectively; a serial number of a frequency domain resource corresponding to the first wave beam direction is an odd number, and a serial number of a frequency domain resource corresponding to the second wave beam direction is an even number;
and alternatively,
a serial number of a frequency domain resource corresponding to the first wave beam direction is an even number, and a serial number of a frequency domain resource corresponding to the second wave beam direction is an odd number.

7. The method according to claim 2, wherein the channel state information comprises at least: a channel quality indicator (CQI).

8. The method according to claim 2, wherein modulation and coding schemes (MCSs) used by different types of channel state information are different, and code rates and/or modulation orders of the different MCSs are different.

9. The method according to claim 8, wherein the frequency domain resource allocation strategy is the second strategy, and the numbers of the frequency domain resources for the antenna panels are determined according to a ratio coefficient; and
the ratio coefficient is determined according to code rates and modulation orders for the antenna panels of the terminal to perform the PUSCH transmission.

10. The method according to claim 9, wherein two antenna panels are arranged at the terminal, and wave beam directions corresponding to the two antenna panels comprise: a first wave beam direction and a second wave beam direction;
ratio coefficient Ratio₁ corresponding to the first wave beam direction is:
$${Ratio}_{1} = R 1 * \frac{Qm 1}{R 2 * Qm 2} ;$$
and
ratio coefficient Ratio₂ corresponding to the second wave beam direction is:
$${Ratio}_{2} = R 2 * \frac{Qm 2}{R 1 * Qm 1} .$$

11. The method according to claim 10, wherein
a serial number of a frequency domain resource corresponding to the first wave beam direction is [0, floor(N_rb/1+Ratio₁)−1], and a serial number of a frequency domain resource occupied by a second antenna panel is (floor(N_rb/(1+Ratio₁)−1, N_rb];
and alternatively,
a serial number of a frequency domain resource corresponding to the second wave beam direction is [0, floor(N_rb/(1+Ratio₂)−1], and a serial number of a frequency domain resource occupied by a first antenna panel is (floor(N_rb/(1+Ratio₂)−1, N_rb].

12. The method according to claim 10, wherein frequency domain resources for the terminal are divided by M_rb and have serial numbers of 0 to ceil(N_rb/M_rb);
a serial number of a frequency domain resource corresponding to the first wave beam direction is [0, ceil((Ratio₁/(Ratio₁+Ratio₂)*ceil(N_rb/M_rb))], and a serial number of a frequency domain resource occupied by a second antenna panel is (ceil((Ratio₁/(Ratio₁+Ratio₂)*ceil(N_rb/M_rb)), ceil(N_rb/M_rb)];
and alternatively,
a serial number of a frequency domain resource corresponding to the second wave beam direction is [0, ceil((Ratio₂/(Ratio₁+Ratio₂)*ceil(N_rb/M_rb))], and a serial number of a frequency domain resource occupied by a first antenna panel is (ceil((Ratio₂/(Ratio₁+Ratio₂)*ceil(N_rb/M_rb)), ceil(N_rb/M_rb)].

13. The method according to claim 2, wherein one transmission block for the PUSCH transmission corresponds to one code word (CW) or partial information of one code word.

14. The method according to claim 13, wherein
the one code word corresponds to one MCS indication field or a plurality of MCS indication fields; and
the one MCS indication field indicates an MCS used by one antenna panel.

15. The method according to claim 14, wherein in a case that at least one of the plurality of MCS indication fields carries a predetermined bit value, it is indicated that the second strategy is not supported.

16. The method according to claim 2, wherein
whether the second strategy is supported when the plurality of antenna panels of the terminal transmit the PUSCH transmission by using the wave beams is indicated by a high-layer signaling.

17. (canceled)

18. (canceled)

19. The method according to claim 1, wherein FDRA information of the different antenna panels is carried by one FDRA domain;
and alternatively,
FDRA information of the different antenna panels is carried by different FDRA domains.

20. The method according to claim 2, wherein direction of the wave beams include:
a first wave beam direction corresponding to a respective wave beam direction of a first antenna panel of the terminal, or a respective wave beam direction of transmitting a PUCCH to a first TRP of the base station; and
a second wave beam direction corresponding to a respective wave beam direction of a second antenna panel of the terminal, or a respective wave beam direction of transmitting a PUCCH to a second TRP of the base station.

21. (canceled)

22. A communication device, comprising:
a processor,
a transceiver,
a memory, and
an executable program stored in the memory,
wherein the executable program when executed by the processor cause the communication device to:
determine, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station; wherein
the antenna panels transmit the PUSCH transmission by using wave beams, directions of the wave beams used by different antenna panels are indicated by wave beam direction indication information, and the wave beam direction indication information comprises: transmission configuration indication (TCI) or a source indication parameter of a sounding reference signal (SRS).

23. A non-transitory computer storage medium, storing an executable program, the executable program when executed by a processor, causes the processor to perform a method for determining a frequency domain resource as follows:
determining, according to a frequency domain resource allocation strategy and frequency domain resource allocation (FDRA) information of a terminal, the frequency domain resource for a plurality of antenna panels of the terminal to coordinatively transmit physical uplink shared channel (PUSCH) transmission to a plurality of transmission reception points (TRPs) of a base station; wherein
the antenna panels transmit the PUSCH transmission by using wave beams, directions of the wave beams used by different antenna panels are indicated by wave beam direction indication information, and the wave beam direction indication information comprises: transmission configuration indication (TCI) or a source indication parameter of a sounding reference signal (SRS).
